(19) United States
(12) Patent Application Publication
(10) Pub. No.: US 2009/0071075 A1
(43) Pub. Date: Mar. 19, 2009

(54) Door Hinge Having a Lifting Function For the Door

(76) Inventor: Rainer Hoffmann, Langenfeld (DE)

Correspondence Address: ROBERT W. BECKER & ASSOCIATES, 707 HIGHWAY 333, SUITE B, TIJERAS, NM, 87059-7507, US

(21) Appl. No.: 12/212,213

(22) Filed: Sep. 17, 2008

(30) Foreign Application Priority Data
Sep. 18, 2007 (DE) 20 2007 013 070.8

(51) Int. Cl. E05D 15/00

(52) U.S. Cl. 49/260

(57) ABSTRACT

A door hinge for a door mounted on a cabinet in such a way that it can pivot open. A displacement mechanism is installed in the hinge to allow the door to be simultaneously lifted from the frame of the cabinet during a pivoting movement of the door into an open position. The displacement mechanism includes a slide displaceably disposed in a hinge housing secured to the cabinet frame and carrying the door via a mounting element mounted in the door, and a runner integrated in the slide and moveable relative thereto, the runner being connected to the mounting element. A glide layer, made of wear-resistant material having a gliding capability, is disposed between those surfaces of the hinge housing and/or of the slide and/or of the runner that respectively slide against one another during displacement of the slide in the hinge housing and of the runner relative to the slide.

The instant application should be granted the priority date of Sep. 18, 2007 the filing date of the corresponding German patent application 20 2007 013 070.8.

### BACKGROUND OF THE INVENTION

The present invention relates to a door hinge for a door mounted on a cabinet, especially a switch cabinet or the like, in such a way that it can be pivoted open, according to which, by means of a sliding or displacement mechanism installed in the hinge, during the pivoting movement of the door into its open position the door is simultaneously raised from the frame of the cabinet, whereby the displacement mechanism is comprised of a slide that is displaceably disposed in a hinge housing secured to the frame of the cabinet, wherein the slide carries the door via a mounting element mounted on the door, as well as of a runner that is integrated in the slide and is moveable relative thereto, wherein the runner is connected to the mounting element that is mounted on the door.

A hinge having the aforementioned type of construction is described in DE 10 2004 007 823 A1; with regard to the construction and the function of this hinge the disclosure of the aforementioned document is hereby incorporated by this reference. However, the known door hinge has the drawback that in particular with large and heavy doors, the displacement mechanism that is disposed in the hinge housing is difficult to move, and thus in connection with the hinge function material wear or abrasion occurs which can further adversely affect the function of the door hinge.

It is therefore an object of the present invention to eliminate the aforementioned drawbacks of a door hinge of the aforementioned general type.

### BRIEF DESCRIPTION OF THE DRAWING

This object, and other objects and advantages of the present invention, will appear more clearly from the following specification in conjunction with the accompanying schematic drawing, in which:

FIG. 1 is a longitudinal cross-sectional view through a door hinge with the hinge components inserted into one another when the door is closed;

FIG. 2 shows the hinge of FIG. 1 in the open position of the door with the hinge components withdrawn from one another; and

FIG. 3 is a perspective cross-sectional view of the hinge of FIG. 1.

### SUMMARY OF THE INVENTION

The basic concept of the present invention is the provision of a glide layer, made of a wear-resistant material that has a gliding capability, between those surfaces of the hinge housing and/or the slide and/or the runner that respectively slide against one another during displacement of the slide in the hinge housing on the one hand and of the runner relative to the slide on the other hand.

The door hinge of the present application has the advantage that the components of the door hinge that move against one another are respectively supported against one another via the glide layers that are provided, so that no friction, and no wear or abrasion: due to the material of the hinge components themselves, any longer occur.

Pursuant to one embodiment of the invention, the glide layer is made of a wear-resistant polymeric material that has a gliding capability.

Pursuant to a first embodiment of the invention, the glide layer can be formed by a rail-like component that is secured in position in a groove disposed in an associated surface of the hinge housing and/or of the slide and/or of the runner.

Pursuant to an alternative embodiment, the glide layer can be formed by a U-shaped component that extends externally about the slide and is to be supported against the inner abutment surface of the hinge housing. In this connection, depending upon the type of construction, it can be expedient to provide tho glide components that each extend outwardly about the slide and, in the load direction of the hinge due to the door carried by it, are disposed respectively above and below. In this connection, the respectively provided U-shaped glide components can either be secured on the slide or can alternatively be placed into the hinge housing and secured in position therein.

To the extent that the relative moveability between runner and slide is of concern, the runner, via guide extensions that project from it, can be guided in groove guideways that are formed in the slide so as to be moveable relative to the slide, and glide components can be disposed between the groove guideways and the guide extensions.

To improve the ability to move easily, the outer ends of the guide extensions of the runner, and the groove guideways in a shape-corresponding manner, can respectively be formed with a radius, and the glide components that are disposed between the guide extension and the groove guideways can have a conforming shape.

With regard to the mounting of large and heavy doors, pursuant to embodiments of the present invention the hinge housing and the displacement mechanism can respectively be made of a metal, or alternatively of a reinforced polymeric material in particular with such materials and an appropriately massive design, the provision of the inventive glide layers on the components that move relative to one another is advantageous.

Further specific features of the present invention will be described in detail subsequently.

### Description of Specific Embodiments

As described in detail in the aforementioned DE 10 2004 007 823 A1 in one application of the door hinge, a hinge housing 10 is secured to the not-illustrated frame of a cabinet. A sliding or displacement mechanism, as a carrier of a mounting element 11 that is mounted on a door, is disposed in the hinge housing 10, so that the non-illustrated door, via the mounting element 11 mounted thereon, is supported by the displacement mechanism and hence by the hinge housing 10.

The displacement mechanism is comprised primarily of a U-shaped slide 12, and of a runner 13 that is structurally integrated into the U-shaped slide 12, whereby the runner 13 is moveable in the slide 12 relative thereto. The runner 13, in turn, has a two-part configuration, including a first part 14 and a second part, in the form of a swivel arm 15, that is moveably connected with the first part 14 via a pivot pin 16. The swivel arm 15 is curved in the opening direction of the door, and at its free end is connected to the mounting element 11 via a hinge pin 17. The free end of the U-shaped slide 12 that surrounds the runner 13 is, in turn, provided on its free end with a hook or catch 18 that is curved in the door opening direction and at the end of which the slide 12, in turn, is also connected with the mounting element 11 via a hinge pin 19.

To carry out the respective relative movements within the displacement mechanism, disposed on the U-shaped slide 12, on a pivot pin 21, is an externally toothed pinion 20, which on the one hand meshes with a toothing 22 formed on the first part 14 of the runner 12, and on the other hand meshes with a toothing 23 that is secured to the housing and fixedly disposed in the hinge housing 10.

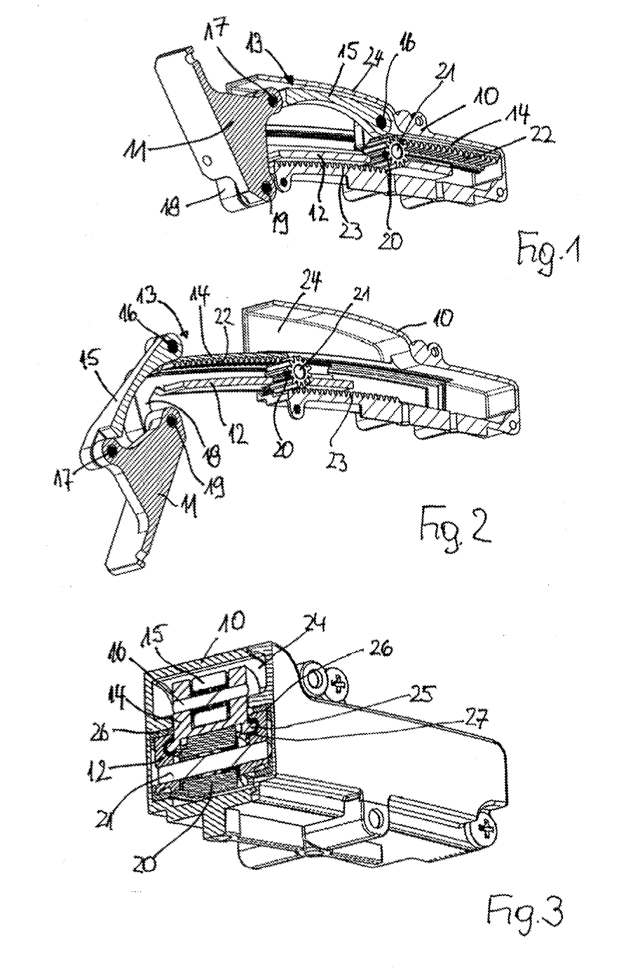

To the extent that the swivel arm 15, as part of the runner 13, is inserted into the hinge housing 10, as can be seen with the closed door position of the cabinet in FIG. 1, the hinge housing 10 is provided in this region with a hollow space 24, so that the curved swivel arm 15, with the runner 13 inserted, fits in the hinge housing 10.

If the closed door, initially in the position of the hinge visible from FIG. 1, is opened, the pivoting movement leads to a withdrawal of the runner 13 from the hinge housing 10. Since the toothing 22 that is formed on the runner 13 meshes with the pinion 20 that is mounted in the slide 12, which pinion, in turn, meshes with the toothing 23 that is secured to the housing, the pinion 20 is displaced along the track or guideway formed by the toothings 22 and 23 and thus also moves the slide 12 out that carries the pinion 20 and that is connected via the hinge pin 19 with the mounting element 11 that is mounted to the door. Due to the two-part construction of the runner 13 having the first part 14 and the swivel arm 15 and their relative moveability relative to one another realized about the pivot pin 16, the runner 13 also follows in the position of the pivoting movement of the door In this regard, the displacement mechanism ensures that with the opening movement of the door at the same time a displacement of the door panel plane, and of the mounting element 11 mounted on the door, takes place between the closed position of FIG. 1 and the open position of FIG. 2.

If the door is closed, the movement process is carried out in the reverse sequence, with the runner 13 and slide 12 again being inserted into the hinge housing 10, and hence assuming the starting position shown in FIG. 1.

As can be seen in detail in FIG. 3, to eliminate a difficulty of movement, i.e. to avoid material wear or abrasion during the relative movements of the slide 12 to the hinge housing 104 as well as of the runner 13 to the slide 12, care must be taken that a glide layer is respectively disposed between the surfaces that slide against one another. In the illustrated embodiment, to form the glide layer between the slide 12 and the associated inner surfaces of the hinge housing 10, U-shaped glide components 26 are provided that respectively externally extend about the slide 12 in a shape-corresponding manner, whereby the two U-shaped glide components 26, in the direction of load of the hinge due to the door carried thereby, are respectively disposed in the upper and in the lower region of the slide 12, to the extent that the movement exerted by the door upon the hinge also acts upon these surfaces.

To the extent that in the illustrated embodiment the runner 13 is guided in the U-shaped slide 12 by guide extensions 25 that project from it, and that are guided in groove guideways that are formed in the associated surfaces of the slide 12 in a shape-corresponding manner, glide components 27 are also disposed between the groove guideways and the guide extensions 25. To the extent that the outer ends of the guide extensions 25, and correspondingly the associated groove guideways, are respectively formed with a radius, also the glide components 27 disposed between them have a conforming shape with corresponding radii.

Although not illustrated further, the glide components can also comprise glide rails that are separately placed into the respective surfaces in a form-fitting manner.

The features of the subject matter of these documents disclosed in the preceding description, the claims, and the drawing can be important individually as well as in any desired combination with one another for realizing the various embodiments of the invention.

The specification incorporates by reference the disclosure of German priority document DE 20 2007 013 070.8 filed Sep. 18, 2007.

The present invention is, of course, in no way restricted to the specific disclosure of the specification and drawing, but also encompasses any modifications within the scope of the appended claims.

What I claim is:

1. A door hinge for a door mounted on a cabinet in such a way that it can pivot open, comprising:
a displacement mechanism installed in the hinge and by means of which the door is adapted to be simultaneously lifted from a frame of a cabinet during a pivoting movement of the door into an open position, said displacement mechanism comprising:
a slide displaceably disposed in a hinge housing secured to the frame of the cabinet, wherein said slide carries the door via a mounting element mounted on the door; and
a runner integrated into said slide and moveable relative thereto, wherein said runner is connected to said mounting element; and
a glide layer, made of a wear-resistant material that has a gliding capability, disposed between those surfaces of at least one of said hinge housing, said slide and said runner that respectively slide against one another during displacement of said slide in said hinge housing and of said runner relative to said slide.

2. A door hinge according to claim 1, wherein said glide layer is made of a wear-resistant polymeric material that has a gliding capability.

3. A door hinge according to claim 1, wherein said glide layer is respectively formed by a rail-like component that is secured in position in a groove disposed in an associated surface of at least one of said hinge housing, said slide and said runner.

4. A door hinge according to claim 1 wherein said glide layer is formed by a U-shaped glide component that externally extends about said slide and is adapted to be supported against inner abutment surfaces of said hinge housing.

5. A door hinge according to claim 4, wherein two glide components are provided that each extend externally about said slide and that, in a direction of load of said hinge caused by the door carried thereby, are respectively disposed above and below.

6. A door hinge according to claim 4 wherein said U-shaped glide components are secured in position on said slide.

7. A door hinge according to claim 4, wherein said U-shaped glide components are inserted into said hinge housing and are fixed in position therein.

8. A door hinge according to claim 1 wherein said runner is provided with guide extensions that project therefrom, further wherein said guide extensions of said runner are guided in groove guideways formed in said slide so that said runner is moveable relative to said slide, and wherein glide components are disposed between said groove guideways and said guide extensions.

9. A door hinge according to claim 8, wherein outer ends of said guide extensions of said runner, and said groove guideways in a shape-corresponding manner, are respectively formed with a radius, and wherein said glide components that are disposed between said guide extensions and said groove guideways are provided with a conforming shape.

10. A door hinge according to claim 1, wherein said hinge housing and said displacement mechanism are respectively made of metal.

11. A door hinge according to claim 1, wherein said displacement mechanism and said hinge housing are respectively made of a reinforced polymeric material.
